(19) United States
(12) Patent Application Publication
(10) Pub. No.: US 2026/0236861 A1
(43) Pub. Date: Aug. 13, 2026

(54) TECHNIQUES FOR IMPROVING LANGUAGE MODEL RESPONSES USING CONTEXT

(71) Applicant: Soroco India Private Limited, Bengaluru (IN)

(72) Inventors: George Peter Nychis, Somerville, MA (US); Rohan Narayana Murty, Bangalore (IN)

(73) Assignee: Soroco India Private Limited, Bengaluru (IN)

(21) Appl. No.: 19/532,198

(22) Filed: Feb. 6, 2026

Related U.S. Application Data
(60) Provisional application No. 63/755,702, filed on Feb. 7, 2025.

(51) Int. Cl. G06Q 10/0631; G06F 16/242; G06F 40/40

(52) U.S. Cl. CPC G06Q 10/063114; G06F 16/243; G06F 40/40

(57) ABSTRACT

Techniques for using language models to respond to queries about a process performed by multiple users in an organization, the method comprising: receiving a query about the process performed by multiple users in the organization; generating context to be used by a language model in responding to the query, the generating comprising: obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and including the obtained historical digital interaction data as part of the context; processing the query and the generated context by using the language model to obtain a response to the query; and outputting the response.

### RELATED APPLICATIONS

This application claims the benefit of U.S. Provisional Patent Application Ser. No. 63/755,702, filed Feb. 7, 2025, titled “LOCALIZING MODELS WITH INTERACTION DATA, LOCAL CONTEXT, AND SHARED USER EXPERIENCES,” which is incorporated by reference herein in its entirety.

### BACKGROUND

Employees at many companies spend much of their time working on computers. An employer may monitor an employee's computer activity by installing a monitoring application program on the employee's work computer to monitor the employee's actions. For example, an employer may install a keystroke logger application on the employee's work computer. The keystroke logger application may be used to capture the employee's keystrokes and store the captured keystrokes in a text file for subsequent analysis.

### SUMMARY

Some embodiments provide for a method of using language models to respond to queries about a process performed by multiple users in an organization, the method comprising: using at least one computer hardware processor to perform: receiving a query about the process performed by multiple users in the organization; generating context to be used by a language model in responding to the query, the generating comprising: obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and including the obtained historical digital interaction data as part of the context; processing the query and the generated context by using the language model to obtain a response to the query; and outputting the response.

In some embodiments, the multiple users include a first user who performed, is performing, or will be performing the process; receiving the query comprises receiving the query from the first user; and outputting the response comprises outputting the response to the first user.

In some embodiments, the method further comprises identifying, within the historical digital interaction data, at least one instance of the process previously performed by at least one user; and including, as part of the context, at least a portion of the historical digital interaction data corresponding to event data associated with the at least one instance of the process previously performed by the at least one user.

In some embodiments, identifying the at least one instance of the process comprises identifying, using instance identifiers associated with previously-determined numeric representations of multiple instances of the process stored in a database, the at least one instance of the process previously performed by the at least one user.

In some embodiments, the first user is performing the process using at least one application program executing on a first computing device; the identifying the at least one instance of the process comprises: obtaining a first stream of event data corresponding to a series of interactions between the first user and the at least one application program; identifying, within the historical digital interaction data and using the first stream of event data, the at least one instance of the process previously performed by at least one user; and the method further comprises: including, as part of the context, the first stream of event data and the at least a portion of the historical digital interaction data corresponding to the event data associated with the at least one instance of the process previously performed by the at least one user.

In some embodiments, the first stream of event data contains event data for each event in a stream of events, and identifying the at least one instance of the process comprises: organizing events in the stream of events into at least one window of events, each of the at least one window of events comprising one or multiple events in the stream of events; generating, using at least one trained embedding machine learning (ML) model, at least one numeric representation corresponding to the at least one window of events; determining a measure of similarity between the at least one numeric representation and each of multiple stored and previously-determined numeric representations of respective window of events in the multiple streams of event data in the historical digital interaction data to obtain a plurality of measures of similarity; and identifying, using the determined plurality of measures of similarity, the at least one instance of the process in the stream of events.

In some embodiments, the at least one window of events comprises a first window comprising a first plurality of events, generating the at least one numeric representation corresponding to the at least one window of events comprises generating a first numeric representation of the first window, wherein generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

In some embodiments, the method further comprises generating a prompt using the query and the context; and prompting the language model with the prompt to obtain output including guidance for the first user performing the process.

In some embodiments, the guidance indicates one or more suggested acts for first user to perform in furtherance of performing the process, and outputting the response comprises presenting the user with the one or more suggested acts that the first user could perform in furtherance of performing the process.

In some embodiments, the method further comprises identifying at least a portion of the first stream of event data to be provided as context to the language model.

In some embodiments, identifying the at least a portion of the first stream of event data to be provided as context to the language model comprises: receiving, via a graphical user interface, user input indicating one or more parameters to refine the first stream of event data; and refining the first stream of event data based on the user input to obtain the at least a portion of the first stream of event data to be provided as context to the language model.

In some embodiments, receiving the query comprises receiving a request to generate an audit trail for the process; and the processing comprises processing the request and the generated context by using the language model to obtain a response to the request including the audit trail for the process.

In some embodiments, a system is provided, the system comprising: at least one computer hardware processor; and at least one non-transitory computer-readable storage medium storing instructions that, when executed by the at least one computer hardware processor cause the at least one computer hardware processor to perform the method of any one of the foregoing embodiments.

In some embodiments, at least one non-transitory computer-readable storage medium is provided, the at least one-non-transitory computer-readable storage medium storing instructions that, when executed by at least one computer hardware processor cause the at least one computer hardware processor to perform the method of any one of the foregoing embodiments.

### BRIEF DESCRIPTION OF DRAWINGS

Various non-limiting embodiments of the technology will be described with reference to the following figures. It should be appreciated that the figures are not necessarily drawn to scale.

FIG. 1 is a block diagram including components of a process tracking system, according to some embodiments of the technology described herein;

FIG. 2A-2B are block diagrams depicting components implemented as part of the process tracking system of FIG. 1, according to some embodiments of the technology described herein.

FIGS. 3A-3B are block diagrams depicting components of a context generation service of FIG. 2A, according to some embodiments of the technology described herein.

FIG. 4 is a flowchart of acts for using language models to respond to queries about a process performed by multiple users in an organization, according to some embodiments of the technology described herein;

FIG. 5 illustrates an example user interface screen that a user may interact with, according to some embodiments of the technology described herein;

FIG. 6 schematically illustrates components of a computer that may be used to implement some embodiments described herein.

### DETAILED DESCRIPTION

Aspects of the technology described herein relate to improving machine learning technology by enhancing the computational efficiency and accuracy of language model responses through use of context derived from digital interaction data. The improvement is achieved by generating context that is used by the language models in responding to queries about processes performed by multiple users in an organization. Context generation techniques described herein involve receiving a query about a process performed by multiple users in the organization; generating context to be used a language model in responding to the query by obtaining historical digital interaction data associated with the process and including the obtained historical digital interaction data as part of the context; processing the query and the generated context by using the language model to obtain a response to the query; and outputting the response.

A “process” refers to a plurality or a series of user actions that are collectively performed using one or more application programs to perform a task. The task may be any suitable task that could be performed by a user (or multiple users) by interacting with one or more computing devices. The task may be any suitable task that one or more users perform in a business such as, for example, one or more accounting, finance, IT, human resources, purchasing, and/or any other types of tasks. For example, a process may refer to a plurality of user actions that a user takes to perform the task of approving a purchase order (which may involve multiple activities such as receiving the purchase order, reviewing the purchase order, and approving it). As another example, a process may refer to a plurality of user actions that a user takes to perform the task of resolving an IT ticket (which may involve multiple activities such as opening an IT ticket for an issue (e.g., resetting a user's password), addressing the issue, and closing same (e.g., by resetting the password and notifying the user whose password was reset that this is completed)). Some processes may include only a few (e.g., 2 or 3) user actions, whereas other processes may include more (e.g., tens, hundreds, or thousands) user actions. For example, a process may include multiple activities each involving the user performing multiple actions.

A user may perform actions of a process by interacting with the one or more application program(s). The software application program(s) may be installed on a computing device to which the user has access (e.g., the user's desktop, laptop, smartphone, tablet, or other computing device). A user may interact with an application program through its user interface, for example, through its graphical user interface (GUI) by performing various acts via GUI elements shown on the application program's GUI screens. Examples of such acts include selecting checkboxes or radio buttons, entering information into fields, clicking on buttons, clicking on text, selecting text, cutting and/or pasting, clinking on links, dragging and dropping, moving, resizing, opening and/or closing a window, etc. A user may also interact with an application program by providing textual commands via a command-line interface or any other suitable interface. User actions may include various actions (e.g., mouse clicks, keystrokes, button presses). Each interaction between a user and an application program may be referred to as a digital interaction step or, more simply, an interaction step.

Accordingly, a user's performance of a particular process using one or more application programs involves the user performing a series of digital interaction steps (e.g., tens, hundreds, thousands, tens of thousands of steps, etc.) in furtherance of the particular process. In some instances, a process may involve the user performing multiple activities as part of the process and the series of interaction steps that the user takes to perform the process may involve different subsets of interaction steps for the different activities part of the process. For example, the series of interaction steps performed by a user in furtherance of a process that involve four different activities may include interaction steps for each of the four different activities. As a specific example, a process for “revenue accounting” may involve multiple activities including “Data Collection”, “Invoice Preparation and Validation”, “Revenue Recognition”, “Reconciliations”, and “Report Generation. Thus, a user performing the “Revenue Accounting” process may perform a series of interaction steps (with one or more appropriate application programs) for each of these five activities.

As described herein, data about how users perform processes may be captured during their performance of such processes. When a user performs a series of interaction steps in order to perform a process, data about the series of interaction steps may be captured and stored. In some embodiments, that data is captured as a stream of event data. A stream of events corresponds to interactions between a user and one or more application programs executing on a computing device with which the user is interacting to perform a process. Events may be ordered in the stream with respect to time at which the events occurred during performance of the process. Individual events in the stream of events may correspond to individual interaction steps (e.g., keystrokes, clicks, button presses, etc.).

In some embodiments, data may be captured about each of at least some (e.g., all) events in a stream of events resulting in a stream of event data. Event data captured for an event may include information indicating the action taken by the user in the event (e.g., a click or keystroke) and associated metadata providing information about the context in which the user's action was taken. Non-limiting examples of such metadata include a unique identifier assigned to the event, an identifier for the computing device with which the user interacted during the event, a name of the application program with which the user interacted during the event, a title of an application program screen of the application program with which the user interacted during the event, an identifier of the user interface element of the application program screen with which the user interacted during the event, a type of the user interface element of the application program screen with which the user interacted during the event, one or more identifiers for one or more user interface elements of the application program screen with which the user did not interact during event, values shown in any user interface elements on the screen during the event, a duration of the interaction, and one or more textual phrases and/or sentences appearing on the application program screen.

Historical digital interaction data refers to previously-captured multiple streams of event data. Each particular stream of event data, from among the multiple streams, may correspond to a series of interactions between one or more application programs executing on particular computing device and a particular user performing a process using the one or more application programs. Historical digital interaction data may contain streams of event data captured for any suitable number of users (e.g., one, tens, hundreds, thousands, tens of thousands, etc.). For example, in some embodiments, historical digital interaction data may contain streams of event data for a group of users at a company (e.g., users on one team, users in one department or division, users in one physical location, users in one geographic region, etc.). Historical digital interaction data may contain streams of event data captured over any suitable period of time (e.g., over an hour, multiple hours, a day, multiple days, week, multiple weeks, a month, multiple months, a year, or multiple years, or any suitable period of time between minutes and years), as aspects of the technology described herein are not limited in this respect. Historical digital interaction data may contain any suitable number streams of event data (e.g., tens, hundreds, thousands, tens of thousands, millions, tens of millions, hundreds of millions, etc.), as aspects of the technology described herein are applicable regardless of the number of streams of event data part of historical event data. Historical digital interaction data may contain streams of data for any suitable number of processes (e.g., tens, hundreds, thousands, etc.). For example, users at an enterprise business may perform thousands or tens of thousands of different processes and the historical digital interaction data may include streams of event data captured during performance of these various processes by users in the enterprise business.

Process discovery refers to identifying, within historical digital interaction data, one or more streams of event data that correspond to one or more users performing a particular process of interest. Such discovered streams of event data may be referred to as process instances. Importantly, the process discovery techniques described herein are efficient and can be effectively used to discover instances of a process being performed within historical digital interaction data even when the historical digital interaction data is large having thousands, millions, tens of millions or hundreds of millions of streams of data corresponding to tens, hundreds, thousands, or tens of thousands of different processes, and collected from tens, hundreds, thousands, or tens of thousands of users.

Process discovery involves having subject matter experts (SMEs), being expert in performing a particular process, record multiple instances of themselves performing that particular process. A process discovery system can then use data derived from such recorded instances to discover process instances in historical digital interaction data. In this sense, SMEs can be said to teach the process discovery system how to discover instances of a particular process by providing the process discovery system with examples—taught process instances or “teachings”. Methods for process discovery based on taught process instances are described in U.S. Pat. No. 11,816,112, titled “Systems and Methods for Automated Process Discovery”, filed on Apr. 2, 2021, and granted on Nov. 14, 2023, as well as PCT Patent Publication WO2024/214113, titled “Machine Learning Systems and Methods for Automated Process Discovery”, filed on Apr. 10 2024 and published on Oct. 17, 2024, each of which is incorporated by reference in its entirety herein.

In certain situations, a user may have queries about a process and turn to a language model, such as ChatGPT, to seek answers. Language models are generative machine learning (ML) models that are trained on large corpora of text to generate textual content in response to one or more input prompts. The corpora of text are collected from various sources, such as web pages, digitized books, transcripts, online questions and answers and other sources of text. The trained language model can summarize text, answer questions about text, provide technical support for users and more.

As one example, a user may need assistance with a technology-related issue and prompt the language model to obtain answers regarding why an error has occurred. For example, a user unable to login to the organization's production servers using a publicly available tool, such as Teleport may ask a language model for assistance. The user may generate a query for the language model. An example query provided as an input prompt is shown below:
“I can't connect to my company's production teleport server. The list of servers when I run “tsh ls” is empty, what could be wrong?”

In response, the language model may generate a generic response which includes a long list of possible causes for the error and corresponding solutions. An example language model response is shown below:

“If you're unable to see your company's production teleport server when running tsh ls, here are some common issues and troubleshooting steps:
1. Missing Roles or Permissions
   Your user may lack the required permissions or roles to view the production environment.
   Fix: Contact the Teleport admin to verify your user roles and ensure you have access to the server.
2. Server Not Connected or Offline
   The production server may not be registered or currently offline.
   Fix: Check with the server admin to confirm that the production server is connected and healthy. You can also use tctl nodes ls if you have cluster admin privileges to verify the server status.
3. Authentication Issues
   Are you logged in? Run tsh status to check if you're logged in to your teleport cluster.
   Fix: If you're not logged in, authenticate using:
   tsh login --proxy=<proxy-address>--cluster=<cluster-name>
4. Incorrect Proxy or Cluster Name
   Ensure the --proxy and --cluster arguments match your company's production teleport setup.
   Fix: Verify the correct proxy URL and cluster name with your team.
5. Network Issues
   Your local machine might not be able to reach the Teleport proxy or the server due to a firewall, VPN, or other networking issues.
   Fix: Ensure your network settings allow communication with the Teleport proxy.
6. Configuration Errors on the Server
   The production server might not be properly configured or has been removed from the cluster.
   Fix: Have the server admin verify the Teleport agent configuration on the server (/etc/teleport.yaml) and restart the Teleport service.
7. Outdated or Missing Certificate
   Your local Teleport certificate may have expired.
   Fix: Re-login to regenerate a certificate:
      tsh login--proxy=<proxy-address>
8. Version Mismatch
   If there's a significant version difference between your tsh client and the Teleport cluster, you might experience issues.
   Fix: Ensure your tsh client is up-to-date by checking the installed version:
tsh version

If none of these steps resolve the issue, let me know the error logs or messages you see, and I can help further troubleshoot!”

From this list provided by the language model, the user is unaware of which of the 8 options is the actual problem that the user faces. Therefore, the user has to perform the time-consuming task of troubleshooting and going through the entire list of possible issues to identify the actual problem and its corresponding solution. Moreover, even if the user were to identify the problem, he may not be able to apply the corresponding solution because the response provided by the language model lacks relevant information tailored to the user's organization. For example, a common issue faced by users in an organization is forgetting to specify the proxy when logging in which is suggested by the third option “Authentication Issues” in the language model response. However, even if the user forgot to specify the proxy, the solution indicated in the large language model response is a partial solution because it does not provide details on what proxy address to add or how to add it. Therefore, the user is still unable to resolve the issue.

As another example, a user may need to generate an audit trail for a process. The user may be the one performing the process or someone who reviews audit trails to identify issues (e.g., an auditor). Manually creating the audit trail is time consuming, error prone, and often lacks details needed for proper review. Use of a language model for generating the audit trail results in a generic response without relevant organizational context. For example, a user may manually generate the following audit trail for a process performed for changing a mailing address of a customer. The manually generated audit trail lacks details regarding the various steps taken to perform the process.
“Case ID A561234, SC mailbox from lisa.morris@residentialsecure.com on 5th December 2023, 09:50 AM to Update mailing address from 123 Pine Street to 456 Oak Avenue, Springfield.”

To address the challenges of generic responses generated by language models when used to respond to queries about a process performed by users in an organization, the inventors have developed techniques for improving these responses by generating and providing additional context when prompting the language model. The context to be used by the language model is generated from digital interaction data associated with the process. Streams of event data, from a single user or multiple users, where each stream corresponds to interactions between a particular user performing the process and one or more application programs executing on a particular computing device associated with the particular user, may be used to generate the context. This generated context when used to enhance prompting of the language model results in responses that are tailored to the organization in which the process is performed.

Referring back to the example above in which a user needs assistance with a technology-related issue, the techniques described herein generate context to be used by the language model to improve its response. The inventors have recognized that the language model response can be improved by generating context using (i) digital interaction data associated with interactions performed by the user (e.g., digital interaction data collected up to the time the user prompts the language model for help), and (ii) historical digital interaction data from other members of the organization or other teams. Using the digital interaction data associated with interactions that the user performed as part of performing the process before prompting the model, process discovery techniques can be used to discover, in the historical digital interaction data, a similar series of interactions (e.g., process instances) previously performed by one or multiple other users. Event data associated with one or more of the previously performed process instances may be included as part of the context. The context may be added as organizational context or to the prompt of the language model.

An example of a query for the language model is shown below:

Organizational Context:

Your responses should be tailored to the XYZ organization when asked about technical matters.

Here are steps that someone else performed in XYZ that are similar:
Open Excel and go to a shared monthly tracker.
Responded to an e-mail about Shipping Orders with the subject: “RE: Shipping for May”
Open cmd or powershell or WSL
tsh login --proxy=soroco.teleport.sh:443
tsh ls
Open Gmail and get this information from there.

Prompt:

The following digital interactions were performed:
tsh login --auth=microsoftsaml
tsh ls
I can't connect to my company's production teleport server. The list of servers when I run “tsh ls” is empty, what could be wrong?

The Model Response:
Incorrect Proxy or Cluster Name
Ensure the --proxy and --cluster arguments match your team's teleport setup for the production environment.
Given your team's prior access, the common Steps include:
tsh login --proxy=soroco.teleport.sh:443 --auth=microsoftsaml

This is a substantial improvement to the generic response (provided by a language model without context) which is enhanced by finding one or more shared experiences from one or multiple users. The query may be expanded by including digital interaction data from multiple users in the organizational context or by appending them in the prompt itself to improve the output of the language model. As is clear, the response shown above is substantially better as it includes the exact proxy details (from knowledge regarding the organization and interactions in the organizational context) that the user should use to resolve the issue.

Including context for a language model improves machine learning technology. By providing context to the language model prior to processing the user's query or request, the computational search space that the language model must traverse is reduced, thereby decreasing processing time and resource consumption while simultaneously increasing prediction accuracy. The improved machine learning technology developed by the inventors produces more accurate results that are verifiably correct when compared to expected outputs. These improvements address a specific technical problem in language models known as “hallucination,” where the language model generates responses that appear valid but contain factually incorrect information. By narrowing the range of possible outputs through context, the improved machine learning technology reduces both the frequency and severity of these erroneous outputs, resulting in a more reliable response.

Including digital interaction data as context for a language model improves the language model response in two ways: A) by using a series of digital interactions from the user performing the process or providing the query, the language model is able to generate a better response because it has more context about what led to the error, and B) by using a series of similar digital interactions from another user (e.g., by identifying at least one instance of the process previously performed by at least one user in historical digital interaction data), the language model is able to generate a response contextualized to the organization including the exact details needed.

Adding digital interaction data as context when prompting the language model for purposes of generating an audit trail also results in an improved response with relevant organizational context. For example, the language model may generate the following audit trail for the process performed for changing a mailing address of a customer.
A customer requested (Case ID A561234) to change the mailing address on Policy POL164821 from 123 Pine Street to 456 Oak Avenue, Springfield. The request was initiated by lisa.morris@residentialsecure.com, indicating her office location is changing.
The Customer Service representative reviewed the case in the ticketing system (where it was marked “Assigned” and then updated to “Active”) and confirmed that a verification document (Address_proof_policy_request.pdf) was attached. After copying the Policy ID, the representative switched to the policy ERP system, searched for POL164821, and proceeded to edit the policy details.
Upon selecting “Update Address,” they pasted the new address (456 Oak Avenue, Springfield), attached the verification document, and noted an alert indicating a “new address location may warrant higher premium.” However, the policy checks (e.g., distance within 10 miles, verified email, and no additional costs for address changes) passed successfully.
Finally, the user clicked “Confirm changes.” The policy system updated the address and displayed a success message: “Address successfully updated in the policy records.” There were no errors. Potential follow-up may involve verifying if a premium adjustment is needed for the newly updated address.

Accordingly, some embodiments provide for a method of using language models to respond to queries about a process performed by multiple users in an organization, the method comprising: (A) receiving a query about the process performed by multiple users in the organization; (B) generating context to be used by a language model in responding to the query, the generating comprising obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and including the obtained historical digital interaction data as part of the context; (C) processing the query and the generated context by using the language model to obtain a response to the query; and (D) outputting the response.

In some embodiments, the multiple users include a first user who performed, is performing, or will be performing the process; receiving the query comprises receiving the query from the first user; and outputting the response comprises outputting the response to the first user.

In some embodiments, at least one instance of the process previously performed by at least one user may be identified within the historical digital interaction data; and at least a portion of the historical digital interaction data corresponding to event data associated with the at least one instance of the process previously performed by the at least one user may be included as part of the context.

In some embodiments, the identification of the least one process instance may be performed by locating a numeric representation of the process instance in a database. Accordingly, some embodiments may involve: identifying, using instance identifiers associated with previously-determined numeric representations of multiple instances of the process stored in a database, the at least one instance of the process previously performed by the at least one user.

In some embodiments, the identification of the at least one process instance may be performed using process discovery techniques. Accordingly, some embodiments involve: obtaining a first stream of event data corresponding to a series of interactions between a first user (e.g., the first user performing the process using at least one application program executing on a first computing device) and the at least one application program; and identifying, within the historical digital interaction data and using the first stream of event data, the at least one instance of the process previously performed by at least one user.

In some embodiments, the first stream of event data and the at least a portion of the historical digital interaction data corresponding to the event data associated with the at least one instance of the process previously performed by the at least one user may be included as part of the context.

In some embodiments, the first stream of event data contains event data for each event in a stream of events, and identifying the at least one instance of the process (using process discovery, for example) comprises: organizing events in the stream of events into at least one window of events, each of the at least one window of events comprising one or multiple events in the stream of events; generating, using at least one trained embedding machine learning (ML) model, at least one numeric representation corresponding to the at least one window of events; determining a measure of similarity between the at least one numeric representation and each of multiple stored and previously-determined numeric representations of respective window of events in the multiple streams of event data in the historical digital interaction data to obtain a plurality of measures of similarity; and identifying, using the determined plurality of measures of similarity, the at least one instance of the process in the stream of events.

In some embodiments, the at least one window of events comprises a first window comprising a first plurality of events, the generating the at least one numeric representation corresponding to the at least one window of events comprises generating a first numeric representation of the first window, the generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

In some embodiments, the method further comprises generating a prompt using the query and the context; and prompting the language model with the prompt to obtain output including guidance for the first user performing the process.

In some embodiments, the guidance indicates one or more suggested acts for first user to perform in furtherance of performing the process, and outputting the response comprises presenting the user with the one or more suggested acts that the first user could perform in furtherance of performing the process.

In some embodiments, the method comprises identifying at least a portion of the first stream of event data to be provided as context to the language model. For example, a portion of the first stream of event data may include event data corresponding to interactions performed up to the time the user prompts the language model.

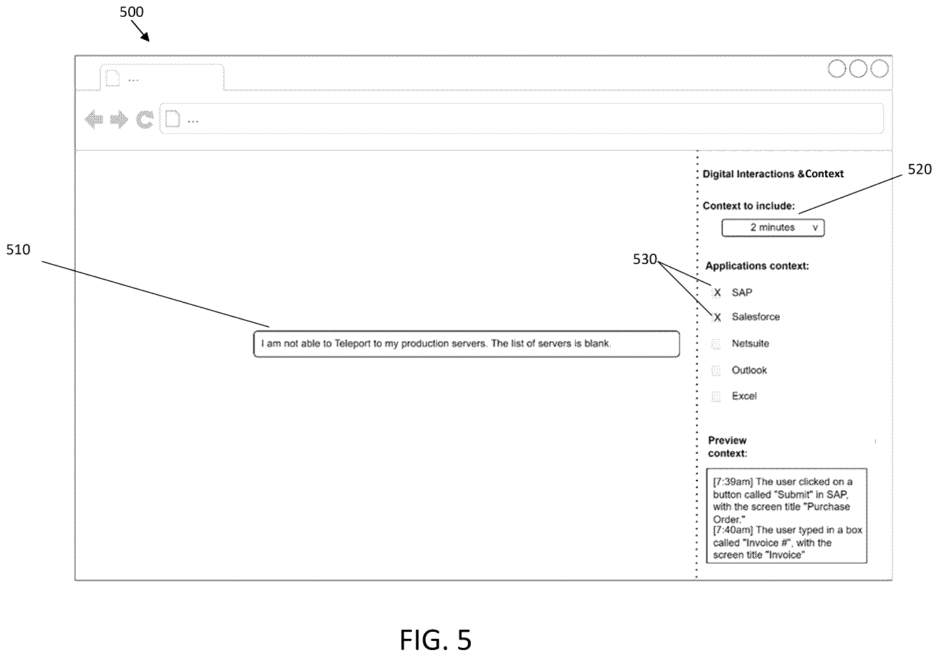

In some embodiments, identifying the at least a portion of the first stream of event data to be provided as context to the language model comprises: receiving, via a graphical user interface (e.g., graphical user interface 500 of FIG. 5), user input indicating one or more parameters to refine the first stream of event data; and refining the first stream of event data based on the user input to obtain the at least a portion of the first stream of event data to be provided as context to the language model.

In some embodiments, the method comprises: receiving the query comprises receiving a request to generate an audit trail for the process; and the processing comprises processing the request and the generated context by using the language model to obtain a response to the request including the audit trail for the process.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

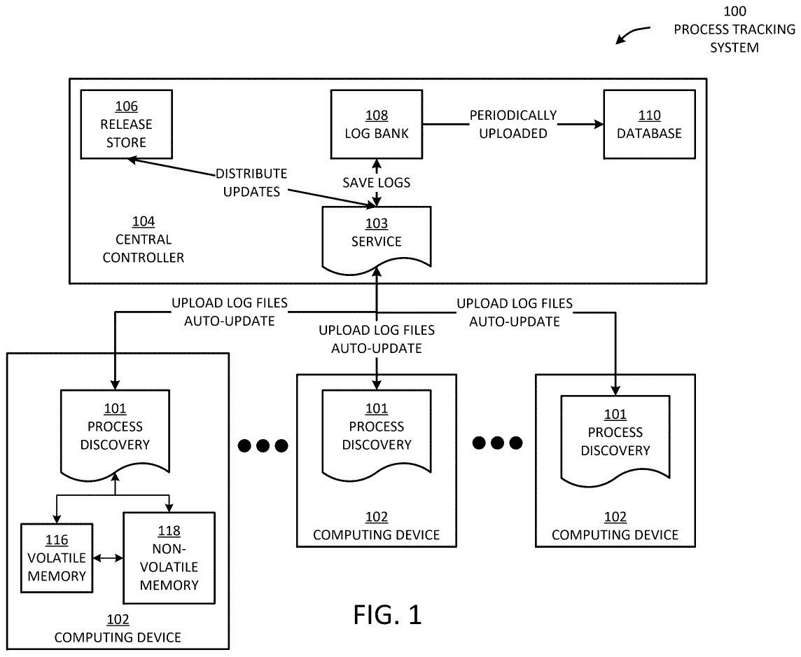

FIG. 1 shows an example process tracking system 100, according to some embodiments. The process tracking system 100 is suitable for tracking one or more processes being performed by users on a plurality of computing devices 102. Each of the computing devices 102 may comprise a volatile memory 116 and a non-volatile memory 118. At least some of the computing devices may be configured to execute process discovery module 101 that tracks user interaction with the respective computing device 102. Process discovery module 101 may be, for example, implemented as a software application and installed on an operating system, such as the WINDOWS® operating system, running on the computing device 102. In another example, process discovery module 101 may be integrated into the operating system running on the computing device 102. In some implementations, process discovery module 101 may include monitoring software installed on computing device 102.

As shown in FIG. 1, process tracking system 100 further includes a central controller 104 that may be a computing device, such as a server, including a release store 106, a log bank 108, and a database 110. The central controller 104 may be configured to execute a service 103 that gathers the computer usage information collected from the process discovery modules 101 executing on the computing devices 102 and store the collected information in the database 110. Service 103 may be implemented in any of a variety of ways including, for example, as a web-application. In some embodiments, service 103 may be a Python Web Server Gateway Interface (WSGI) application that is exposed as a web resource to the process discovery modules 101 running on the computing devices 102.

In some embodiments, process discovery module 101 may monitor the particular tasks being performed on the computing device 102 on which it is running. For example, process discovery module 101 may monitor the task being performed by monitoring actions, such as keystrokes and/or clicks and gathering contextual information associated with each keystroke and/or click. The contextual information may include information indicative of the state of the user interface when the keystroke and/or click occurred. For example, the contextual information may include information regarding a state of the user interface such as the name of the particular application that the user interacted with, the particular button or field that the user interacted with, and/or the uniform resource locator (URL) link in an active web-browser. The contextual information may be leveraged to gain insight regarding the particular task that the user is performing. For example, a software developer may be using computing device 102 to develop source code and may be continuously switching between an application suitable for developing source code and a web-browser to locate code snippets. Unlike traditional keystroke loggers that would merely gather a string of depressed keys including bits of source code and web URLs, process discovery module 101 may advantageously gather useful contextual information such as the particular active application associated with each keystroke. Thereby, the task of developing source code may be more readily identified in the collected data by analyzing the active applications.

The data collection processes performed by process discovery module 101 may be seamless to a user of the computing device 102. For example, process discovery module 101 may gather the computer usage data without introducing a perceivable lag to the user between when one or more actions of a process are performed and when the user interface is updated. Further, process discovery module 101 may automatically store the collected computer usage data in the volatile memory 116 and periodically (or aperiodically or according to a pre-defined schedule) transfer portions of the collected computer usage data from the volatile memory 116 to the non-volatile memory 118. Thereby, process discovery module 101 may automatically upload captured information in the form of log files from the non-volatile memory 118 to service 103 and/or receive updates from service 103. Accordingly, process discovery module 101 may be completely unobtrusive on the user experience.

During data collection, additional information regarding what the user is viewing or interacting with such as application logs, console logs, terminal history, documents (e.g., docx, pptx, pdf) may be collected. This information may include specific details of a process that was being performed, the particular step in a process that was being performed, descriptions of those processes or steps, and/or a sequence that is part of a process or activity. The information may include information regarding communications with other users (using tools such as Teams or Slack), voice interactions with the computing device (e.g., voice to text), code or similar documents that support developers (e.g., product requirements), and/or data aggregated across multiple users (e.g., common patterns, common steps, etc.).

In some embodiments, the process discovery module 101 running on each computing device 102 may upload log files to service 103 that include computer usage information such as information indicative of one or more actions performed by a user on the respective computing device 102 and contextual information associated with those actions. Service 103 may, in turn, receive these log files and store the log files in the log bank 108. Service 103 may also periodically upload the logs in the log bank 108 to a database 110. It should be appreciated that the database 110 may be any type of database including, for example, a relational database such as PostgreSQL. Further, the events stored in the database 110 and/or the log bank 108 may be stored redundantly to reduce the likelihood of data loss from, for example, equipment failures. The redundancy may be added by, for example, by duplicating the log bank 108 and/or the database 110.

In some embodiments, service 103 may distribute updates (e.g., software updates) to the process discovery modules 101 running on each of the computing devices 102. For example, process discovery module 101 may request information regarding the latest updates that are available. In this example, service 103 may respond to the request by reading information from the release store 106 to identify the latest software updates and provide information indicative of the latest update to the process discovery module 101 that issued the request. If the process discovery module 101 returns with a request to download the latest version, the service 103 may retrieve the latest update from the release store 106 and provide the latest update to the process discovery module 101 that issued the request.

In some embodiments, service 103 may implement various security features to ensure that the data that passes between service 103 and one or more process discovery modules 101 is secure. For example, a Public Key Infrastructure may be employed by which process discovery module 101 may authenticate itself using a client certificate to access any part of the service 103. Further, the transactions between process discovery module 101 and service 103 may be performed over HTTPS and thus encrypted.

In some embodiments, service 103 makes the collected computer usage information in the database 110 and/or information based on the collected computer usage information (e.g., quality of attributes, user-level data indicative of how long it takes various users to perform the process, how many times the process is performed across a large organization, and/or other information) available to users. For example, service 103 (or some other component in communication with service 103) may be configured to provide a visual representation of at least some of the information stored in the database 110 and/or information based on the stored information to one or more users (e.g., of computing devices 102). For example, a series of user interface screens that permit a user to interact with the computer usage data in the database 110 and/or information based on the stored computer usage data may be provided as the visual representation. These user interface screens may be accessible over the Internet using, for example, HTTPS. It should be appreciated that service 103 may provide access to the data in the database 110 through still yet other ways. For example, service 103 may accept queries through a command-line interface (CLI), such as psql, or a graphical user interface (GUI), such as pgAdmin.

Some embodiments relate to using user interaction information collected via one or more process discovery modules 101 to generate numeric representation(s) of a process that can then be used to identify instances of the process from captured data corresponding to further user interaction information collected via the one or more of the process discovery modules.

Various components in process tracker system 100 may be used to perform generation of numeric representation(s) during teaching of process instances and/or process discovery. In some embodiments, process discovery may be performed locally on individual computing devices 102 by process discovery modules 101, which may be updated with the most recent numeric representation(s) stored centrally by service 103 periodically, aperiodically or in response to a request from the computing device to provide an update. In some embodiments, process discovery may be performed centrally, with data collected by process discovery modules 101 executing on computing devices 102 being forwarded to service 103, and with service 103 performing process discovery on the received data (from computing devices 102) using the numeric representation(s). In some embodiments, process discovery results may be analyzed using one or more software tools as described herein, and the software tools may execute locally on one or more computing device(s) 102, centrally as part of service 103, and/or in any suitable combination of local and centralized processing. Regardless of whether process discovery is performed locally, centrally, or in a combination of local and central processing, in some embodiments, process discovery results may be provided to one or more users.

In some embodiments, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be automatically created by the process tracking system 100.

In some embodiments, the process tracking system 100 may identify an automatable task based on an automation score generated by analyzing metadata (for example, including the application UI screen metadata described herein) associated with actions or events in the discovered processes. For example, the metadata may be analyzed to determine values for one or more parameters that impact automatability of a given task. Example parameters include but are not limited to, a number of applications employed to perform a task, a number of keystrokes performed in the task, a ratio between keystrokes and clicks performed in the task, and/or other parameters. In some embodiments, the process tracking system 100 may generate the automation score by combining (e.g., linearly combining) the values of these parameters. A determination may be made regarding whether the automation score exceeds a threshold. For example, a task with an automation score that exceeds the threshold may be a good candidate for automation. In response to a determination that the automation score exceeds a threshold, a software robot may be generated to perform the automatable task. Aspects of generating an automation score are described in U.S. Pat. No. 10,831,450, titled “Systems and Methods for Discovering Automatable Tasks, filed on Oct. 26, 2017, and granted Nov. 10, 2020, which is incorporated by reference in its entirety herein.

In some embodiments, a software robot that is configured to perform the automatable task may be generated. The software robot may be configured to control the same set of one or more computer programs employed in the task. The software robot may be generated in any of a variety of ways. In some embodiments, the software robot may be generated using, for example, a sequence of one or more events defining the automatable task. For example, the process tracking system 100 may comprise one or more predetermined software routines for replicating one or more events and the process tracking system 100 may combine these software routines in accordance with the defined sequence of events associated with the task to form a software robot that is configured to perform the task.

In some embodiments, process discovery module 101 may collect action information associated with zero, one or more actions (e.g., a keystroke and/or a click) performed by the user via an application user interface (UI) screen generated by an application program, such as a business application, a desktop application, the Internet Browser, an Operating System, or any other computer software programs executing on computing device 102. In some instances, the process discovery module 101 may consider zero action to be performed when interaction with a graphical user element (GUI) element on a first application UI screen causes a second application UI screen to be presented rather than causing a particular action to be performed on the first application UI screen.

The process discovery module 101 may also collect contextual information associated with GUI elements that are visible in the application UI screen. These GUI elements may include elements, such as buttons or menus that the user interacts with and/or elements, such as fields or labels that the user does not interact with. In some embodiments, the process discovery module 101 may collect contextual information associated with GUI elements not visible in a UI screen. The contextual information may be analyzed to identify a number of attributes for the application UI screen. Each attribute may correspond to at least one GUI element visible in the application UI screen. While in some embodiments, contextual information associated with visible GUI elements is collected, in other embodiments, contextual information associated with visible and invisible UI elements may be collected.

In some embodiments, one or more users “teach” the process by performing a plurality of actions that collectively form the process while interactions between the user and their computing device are captured (e.g., by using a process discovery module 101 executing on the computing device). Each performance of the process by a user may be called an “instance” of the process, and the data captured during the user's performance of the instance may be stored in association with the instance (e.g., in association with an instance identifier corresponding to the instance of the process). Specifically, with respect to teaching, an instance performed during teaching may be called a “teaching instance” performed by a user, and a collection of instances taught by one or more users for a particular process may be called the “taught instances” for that process.

As described above, data about how users perform processes may be captured during their performance of such processes. That includes situations where a user is “teaching” an instance of a process. When a user performs a series of interaction steps in order to perform a process, a stream of event data corresponding to the series of interaction steps may be captured and stored. Individual events in the stream of events may correspond to individual interaction steps (e.g., keystrokes, clicks, button presses, etc.). Event data captured for an event may include information indicating the action taken by the user in the event (e.g., a click or keystroke) and associated metadata providing information about the context in which the user's action was taken.

Data corresponding to the stream of events may be collected in any suitable way. In some embodiments the information may be collected as a user interacts with a computer. For instance, an application (e.g., process discovery module 101 shown in FIG. 1) may be installed on the user's computer that collects data as the user interacts with the computer to perform a process. In some embodiments, each user interaction such as a mouse click, keyboard key press, or voice command that a user performs may be considered as an “event.” For each event, metadata associated with the event may be collected. Aspects of the collecting information as the user interacts with a computer are described herein and in U.S. Pat. No. 10,831,450. Non-limiting examples of metadata that may be collected for each event include, but are not limited to:
Application (e.g., the name of an application program, such as an operating system (e.g., Microsoft Windows, Mac OS, Linux) application, a web application, or a mobile application)
Screen Title (e.g., the title appearing on an application program screen such as the name of the tab in a web browser, the name of a file open in an application, etc.)
Element Identifier(s) (e.g., identifier(s) of user interface element(s) of the application program screen with which the user interacted and/or identifier(s) for user interface element(s) of the application program screen with which the user did not interact)
Element Type (e.g., the type of a user interface element of the application program screen with which the user interacted, such as “button”, “input”, “dropdown” etc.)
Element Name (e.g., the name of a user interface element of the application program screen with which the user interacted such as a name of a button, label of input, etc.)
Duration of the interaction
One or more textual phrases and/or sentences appearing on the application program screen (e.g., subject and body of emails in an email application (e.g., Outlook); content of a spreadsheet or document, such as, a list of special words that are colored, italicized, bolded or highlighted, in the spreadsheet or document application (e.g., Excel, Word, Adobe reader); text displayed on the screen of a mainframe application, etc.)

In some embodiments, metadata associated with an event may additionally include an event identifier. The event identifier may be in any suitable format, such as, numeric, alphanumeric, or other format. For example, an event identifier may be combination of digits, alphabets, and special characters, such as, an underscore.

It should be appreciated that the above-described architecture in which some functions are performed locally on computing devices 102 and other functions are performed centrally (e.g., on a server) is only one such embodiment, and various other architectures in which all functions (e.g., generation of numeric representation(s), process discovery, context generation) are performed locally, all functions are performed remotely, or a mixture of local and remote resources are used to perform the functions described herein are also contemplated as being part of the technology described herein.

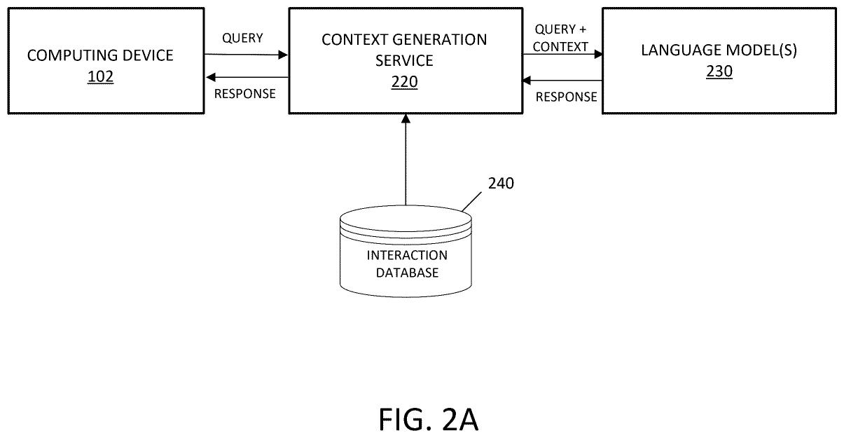

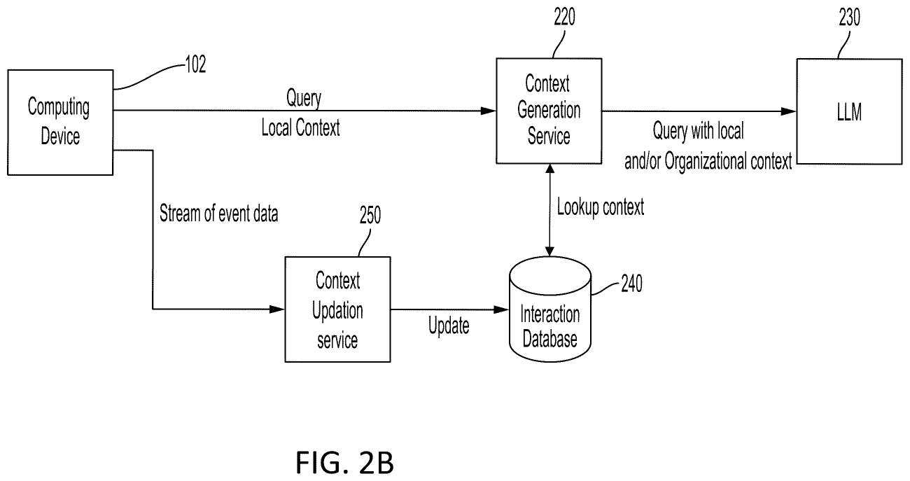

FIGS. 2A-2B are block diagrams depicting components implemented as part of the process tracking system of FIG. 1, according to some embodiments of the technology described herein. In some embodiments, as shown in FIG. 2A, context generation service 220 may generate context to be used by one or more language models 230 in responding to a query about a process performed by multiple users in the organization.

As described herein, information corresponding to a stream of events may be collected as a user interacts with one or more application programs executing on computing device 102. For instance, an application (e.g., process discovery module 101 shown in FIG. 1) may be installed on the user's computing device 102 that collects data as the user interacts with the computing device to perform a process. In some embodiments, each user interaction step such as a mouse click, keyboard key press, or voice command that a user performs may be considered as an “event.” For each event, metadata associated with the event may be collected. Metadata associated with an event may comprise attribute-values pairs derived from information about the interaction between the user and a GUI of the application program. Examples of attribute-value pairs include, but are not limited to:

| Field Name | Description |
|---|---|
| ID | Unique event identifier |
| Machine Name | User Machine Name |
| Application Label | Application Label |
| Screen Title | Title of the Screen |
| Action | User action (e.g., click or keystroke) |
| Interacted Field | Interacted Field Name |
| Interacted Value | Interacted Field Value |
| Screen Text | Screen text extracted from Visual Hierarchy |
| Identifiers | Key-value pairs of fields on the screen from |
| | the Visual Hierarchy |
| Visual Hierarchy | Structured view of on-screen elements and |
| | their relationships |
| Timestamp | Event timestamp |

In some embodiments, the attribute-value pairs comprise values for one or more attributes selected from the group consisting of: a name of the application program, a title of an application program screen of the application program with which the user interacted during the first event, an identifier of the user interface element of the application program screen with which the user interacted, a type of the user interface element of the application program screen with which the user interacted, one or more identifiers for one or more user interface elements of the application program screen with which the user did not interact, a duration of the interaction, and one or more textual phrases and/or sentences appearing on the application program screen.

As users interact with application programs on their computing devices, a series of digital interactions that contain some or all of the information above is captured. These digital interactions are streamed while a user performs a process. The resulting stream of event data can be leveraged by context generation service 220 to generate context to be used by one or more language models 230 in responding to the query about the process.

In some embodiments, context generation service 220 may receive, from a user of computing device 102, the query about the process performed by multiple users in the organization. For example, the query may include a request to generate an audit trail for the process. As another example, the query may include a request to identify a cause of a system, connection, and/or network related error that occurred as part of performing the process and a corresponding solution to resolve the issue. As yet another example, the query may include a request to generate particular content tailored to the organization in which the process is performed.

In some embodiments, the query about the process may be received and provided to the context generation service 220 in any suitable way. For example, the user query may be received via a graphical user interface (GUI). The GUI may be configured to receive the query using any GUI element(s) suitable for receiving text input (e.g., a text box, a search box, etc.). As another example, the query may be provided by voice dictation. FIG. 5 shows an illustrative GUI 500 that receives, via GUI element 510, the query “I am not able to Teleport to my production servers. The list of servers is blank.”

In some embodiments, context generation service 220 may generate context to be used by a language model 230 in responding to the query. Context generation service 220 may generate the context by obtaining historical digital interaction data associated with the process from interaction database 240 and including the obtained historical digital interaction data as part of the context.

In some embodiments, the historical digital interaction data includes multiple streams of event data generated through multiple users performing the process, where each of the multiple streams of event data corresponds to interactions between a particular user performing the process and one or more application programs executing on a particular computing device associated with the particular user. The interaction database 240 may include streams of event data from any suitable number of users, as aspects of the technology described herein are not limited in this respect. Moreover, the interaction database 240 may include one or more streams of event data from the user who provided the query and/or one or more streams of event data from one or more users other than the user who provided the query.

In some embodiments, the interaction database 240 may store raw event data associated with each of multiple processes relevant to the organization and performed by users of the organization and/or one or more numeric representations generated for each of the multiple processes. In some embodiments, event data captured during the user's performance of each instance of a process may be stored in association with an instance identifier corresponding to the instance in the interaction database 240. In some embodiments, a numeric representation of each instance of a process may be stored in association with an instance identifier corresponding to the instance in the interaction database 240. In some embodiments, the one or more numeric representations are stored in a database with vector indexing capabilities such that a vector search can be performed to find representations that are most similar to known representations.

Each performance of the process by a user may be called an “instance” of the process, and the data captured during the user's performance of the instance may be stored in association with the instance (e.g., in association with an instance identifier corresponding to the instance of the process and/or a numeric representation of the instance).

In embodiments where the user providing the query is the one performing the process, event data associated with the user performing the process may also be provided to the context generation service 220—indicated as “local context” in FIG. 2B. In these embodiments, context generation service 220 may include, as context, (i) “local context” which includes event data associated with the user performing the process, for example, event data including interactions performed by the user for a certain period leading up to the time the user provides the query (such as 30 seconds, 1 minute, 2 minutes or another period of time) and (ii) “organizational context” which includes event data associated with at least one instance of the process previously performed by at least one user (the same user or different users). In this way, context to be used by the language model 230 can be enhanced by including not only local context but also organizational context inferred from prior experiences of users performing the process (e.g., from the historical digital interaction data).

In some embodiments, the query and the local context may be communicated to the context generation service 220 as an HTTP POST request by including the query and/or the local context in the body of the request. In some embodiments, the local context may be included in the body as a JSON string. For example, a JSON string may include at least a portion of the metadata associated with (e.g., the attribute-value pairs derived from) the stream of event data corresponding to the interactions between the user performing the process and at least one application program executing on the user's computing device.

In some embodiments, the context generation service 220 may communicate the query and the generated context (e.g., local and organizational context) to the language model 230. In some embodiments, language model 230 is a large language model (LLM). Examples of language models that may use the generated context may include, but are not limited to, transformer-based architectures such as GPT models, BERT, Claude, PaLM, Gemini, LLAMA, and/or other neural network-based natural language processing models.

Language model 230 may process the query and the generated context and output a response to the query. In some embodiments, the context generation service 220 may generate a prompt using the query and the context and communicate the prompt to the language model 230. The language model 230 is prompted with the prompt to obtain output including a response to the query.

In some embodiments, the output may include guidance for the user performing the process. The guidance may indicate one or more suggested acts for the user to perform in furtherance of performing the process. For example, when the user is requesting help with resolving a technology-related issue, the guidance may indicate acts for the user to perform (e.g., enter particular proxy details) to resolve the issue.

In some embodiments, as shown in FIG. 2A, the language model 230 may communicate the response to the context generation service 220 which in turn may communicate the response to the user who provided the query.

In embodiments where the user providing the query is not performing the process but is requesting information about the process, such as an auditor requesting an audit trail for a process performed by one or more other users, event data associated with the other user's performance of the process may be used by the context generation service 220 to generate context for the language model 230. For example, an auditor may request an audit trail for a process performed by a single member or multiple members of a team. In these embodiments, the auditor may provide details regarding the process, the team, and/or particular users performing the process as part of the query. Context generation service 220 may use the details included as part of the query to identify, within the historical digital interaction data, at least one instance of the process previously performed by at least one user. In some embodiments, the query may include one or more instance identifiers associated with one or more instances of the process, one or more numeric representations or signatures of the one or more instances of the process, and/or process classification labels associated with the one or more instances of the process. Details regarding generation of numeric representations or signatures of the process are described in U.S. Pat. No. 11,816,112 and PCT Patent Publication WO2024/214113.

In some embodiments, the at least one instance of the process previously performed by at least one user may be identified using instance identifiers associated with previously-determined numeric representations of multiple instances of the process stored in interaction database 240. In these embodiments, the instance identifier included in the query is compared with instance identifiers associated with previously-determined numeric representations of multiple instances of the process stored in interaction database 240 to identify the at least one instance of the process previously performed by at least one user.

In some embodiments, the at least one instance of the process previously performed by at least one user may be identified by determining a measure of similarity between the numerical representation of the process included in the query and each of multiple previously-determined numeric representations of multiple instances of the process stored in the interaction database 240. The determined plurality of measures of similarity may be used to identify at least one instance of the process previously performed by at least one user whose determined measure of similarity to the numerical representation of the process included in the query was greater than a first threshold (0.7 or 70%). Any suitable first threshold may be used.

Context generation service 220 may include, as part of the context, at least a portion of the historical digital interaction data corresponding to event data associated with the identified instance of the process previously performed by the at least one user. In some embodiments, the context generation service 220 may communicate the query and the generated context (e.g., organizational context) to the language model 230. Language model 230 may process the query and the generated context and output a response to the query. For example, the response to the query may include the audit trail for the process. In some embodiments, the language model 230 may communicate the response to the context generation service 220 which in turn may communicate the response to the user who provided the query.

In some embodiments, the context may be stored in association with the instance identifier and/or numeric representation of the instance of the process in the interaction database 240. In some embodiments, as the user continues to perform a process, streams of events data are continuously obtained and the context may be updated based on the obtained data by context updating service 250. The context stored in the interaction database 240 may be updated accordingly.

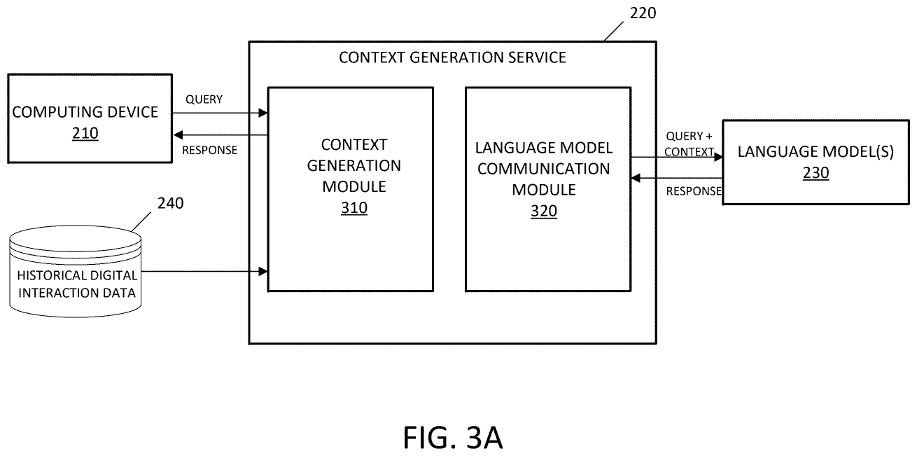

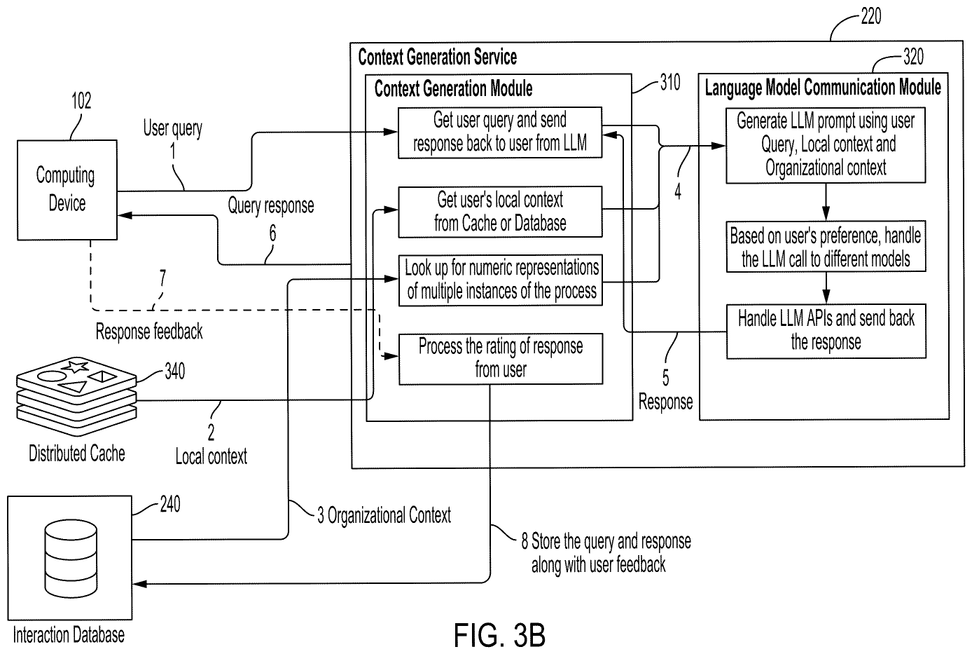

As shown in FIG. 3A, context generation service 220 may include a context generation module 310 and a language model communication module 320. The context generation module 310 may receive the query about the process performed by multiple users in the organization (shown as step (1) in FIG. 3B) and generate context to be used by a language model 230 in responding to the query.

In some embodiments, to generate the context, context generation module 310 may obtain a stream of event data (in other words, the local context) from computing device 210. In some embodiments, the stream of event data may be obtained from a local cache of the computing device 210. In some embodiments, event data may be captured continuously as the user is performing the process. The stream of event data may correspond to a series of interactions occurring within a fixed window of time (e.g., last 5 seconds, last 10 seconds, last 25 seconds, last 30 seconds, last minute, last 2 minutes, last 5 minutes, etc.). Data associated with the series of interactions occurring within the fixed window of time may be stored in memory (e.g., volatile memory or a local cache) and, for example, be used to identify previously-performed processes containing similar series of interactions.

In some embodiments, the stream of event data may be obtained from a distributed cache 340 (shown as step (2) in FIG. 3B) that stores event data associated with the user performing the process. In some embodiments, the distributed cache may be implemented as an in-memory distributed caching service that stores frequently accessed data, such as Azure Cache or Amazon ElastiCache for Redis (Remote Dictionary Server).

In some embodiments, to generate the context, context generation module 310 may obtain historical digital interaction data from interaction database 240 (shown as step (3) in FIG. 3B). In some embodiments, the context generation module 310 may identify, within the historical digital interaction data, at least one instance of the process previously performed by at least one user, and include, as part of the context, at least a portion of the historical digital interaction data corresponding to event data associated with the previously performed process instance (in other words, the organizational context).

In some embodiments, the context generation module 310 may communicate the query, the local context and/or the organizational context to the language model communication (LMC) module 320 (shown as step (4) of FIG. 3B). The LMC module 320 manages communications with one or more language models 230 for purposes of obtaining a response to the query. In some embodiments, the LMC module 320 may generate a prompt for the language model using the user query, the local context and/or the organizational context. As shown in FIG. 3B, the LMC module 320 may handle calls to one or more language models (e.g., handle calls to externally hosted LLM(s) by sending requests over the internet to a third-party provider's servers, such as Open AI, Anthropic, Google, or other LLM service providers). In some embodiments, the LMC module 320 may communicate the prompt to the one or more language models as Application Programming Interface (API) requests. In some embodiments, the user's query, local context and/or organizational context may be packaged into a structured data format using HTTPS protocol for secure transmission.

In some embodiments, the LMC module 320 may obtain the response from language model(s) 230. The response may be provided as JSON or another structured data format. The LMC module 320 may communicate the response to the context generation module 310 (shown as step (5) in FIG. 3B). The context generation module 310 may in turn communicate the response to the user who provided the query (shown as step (6) in FIG. 3B).

In some embodiments, the context generation module 310 may optionally receive feedback regarding the response from the user (shown as step (7) in FIG. 3B). In some embodiments, user feedback to the response may be obtained in any suitable way. As one example, user feedback may be obtained through ratings where the user may rate the response on a particular scale, such as 1-5 rating scale, with 1 referring to a bad response (e.g., irrelevant or not containing user information) and 5 referring to an excellent response (e.g., accurate and extremely useful information). As another example, user feedback may be obtained in the form of comments, where the user may provide textual feedback regarding accuracy and usefulness of the response. In embodiments where user feedback is received, the query, the response and the user feedback may be stored in the interaction database 240 in association with event data and/or numerical representation of the process (shown as step (8) in FIG. 3B). In embodiments, where user feedback is not received, the query and the response may be stored in the interaction database 240 in association with event data and/or numerical representation of the process.

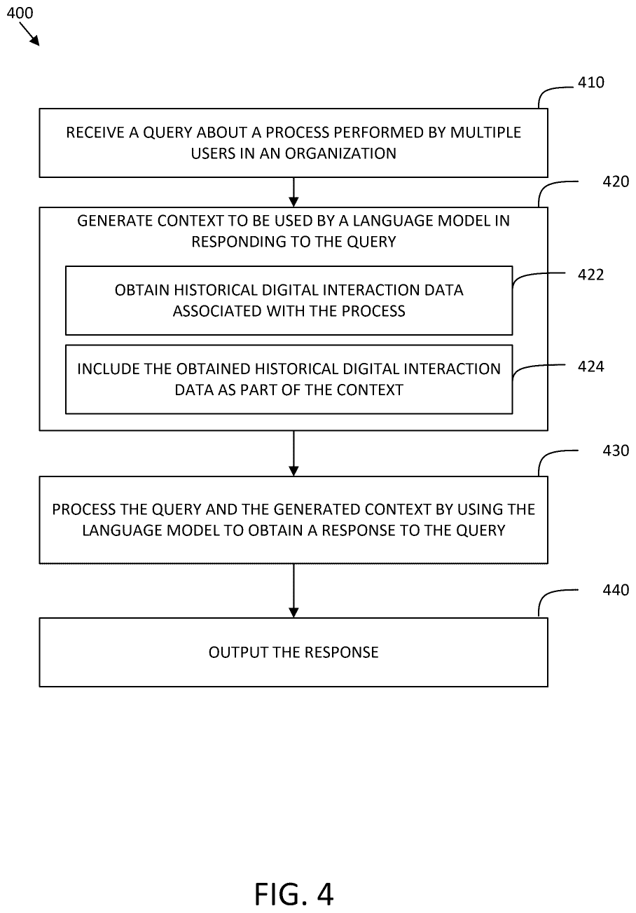

FIG. 4 is a flowchart of an illustrative method 400 for using language models to respond to queries about a process performed by multiple users in an organization, in accordance with some embodiments of the technology described herein. At least some of the acts of method 400 may be performed by any suitable computing device or devices, and, for example, may be performed by one or more of the computing devices 102 and/or central controller 104 shown in process tracking system 100 of FIG. 1.

In act 410, a query about a process performed by multiple users in an organization may be received. As one example, the query may include a request to generate an audit trail for the process. As another example, the query may include a request to identify a cause of a system, connection, and/or network related error that occurred as part of performing the process and a corresponding solution to resolve the issue. As yet another example, the query may include a request to generate particular content tailored to the organization in which the process is performed.

In act 420, context to be used by a language model in responding to the query may be generated. The context may be generated by performing act 422 of obtaining historical digital interaction data associated with the process and act 424 of including the obtained historical digital interaction data as part of the context. In some embodiments, in act 422, the historical digital interaction data may be obtained from interaction database 240. The historical digital interaction data includes multiple streams of event data generated through multiple users performing the process, each of the multiple streams of event data corresponding to interactions between a particular user performing the process and one or more application programs executing on a particular computing device associated with the particular user.

In some embodiments, the query may be received from a first user performing the process and the context to be used by the language model may be generated using a stream of event data corresponding to a series of interactions between the first user and at least one application used by the first user to perform the process. The events collected while the user interacts with the at least one application during performance of the process may be considered a stream of events sorted with respect to the time at which the events occurred during performance of the process. For each event, metadata associated with the event may be collected as described herein. In some embodiments, event data may be captured continuously as the user is performing the process. The stream of event data may correspond to a series of interactions occurring within a fixed window of time (e.g., last 5 seconds, last 10 seconds, last 25 seconds, last 30 seconds, last minute, last 2 minutes, last 5 minutes, etc.). This can be implemented with a buffer, cache or other storage mechanism, whereby data associated with the series of interactions occurring within the fixed window of time are stored and, for example, used to identify previously-performed processes containing similar series of interactions within the historical digital interaction data.

In some embodiments, the context to be used by the language model may be generated by identifying at least a portion of the historical digital interaction data (organizational context) corresponding to event data associated with the at least one instance of the process previously performed by the at least one user. In act 424, the identified at least a portion of the historical digital interaction data may be included as part of the context to be used by the language model.

In some embodiments, the context to be used by the language model may be generated by identifying at least a portion of the stream of event data (local context) associated with the first user performing the process and identifying at least a portion of the historical digital interaction data (organizational context) corresponding to event data associated with the at least one instance of the process previously performed by the at least one user. In these embodiments, the at least a portion of the stream of event data and the at least a portion of the historical digital interaction data may be included as part of the context to be used by the language model.

In some embodiments, the at least a portion of the stream of event data to be provided as context to the language model may be identified by receiving, via a GUI (e.g., GUI 500 of FIG. 5), user input indicating one or more parameters (e.g., duration, application type, and/or other parameters) to refine the first stream of event data; and refining the first stream of event data based on the user input to obtain the at least a portion of the first stream of event data to be provided as context to the language model. As shown in FIG. 5, the user may select two minutes for the duration parameter via GUI element 520, which is a drop-down menu. Also shown in FIG. 5, the user may select “SAP” and “Salesforce” for the application type parameter via GUI element(s) 530, which is a check box. The parameter values may be used to refine the first stream of event data. For example, based on the selections shown in GUI 500, the first stream of event data may be refined to include the user's interactions with the SAP and Salesforce applications up to 2 minutes before the query is provided. A preview of the interactions in the refined stream of event data is shown under the “Preview Context” heading in FIG. 5.

In some embodiments, the at least one instance of the process previously performed by the at least one user may be identified using instance identifiers associated with previously-determined numeric representations of multiple instances of the process stored in the interaction database 240.

In some embodiments, the at least one instance of the process previously performed by at least one user may be identified within the historical digital interaction data and using the stream of event data associated with the first user performing the process. In some embodiments, the at least one instance of the process may be identified by generating, using at least one trained machine learning model, a numerical representation of the process corresponding to the stream of events and determining a measure of similarity between the numerical representation of the process and each of multiple stored and previously-determined numeric representations of the process.

In some embodiments, the stream of event data contains event data for each event in a stream of events. Events in the stream of events may be organized into at least one window of events, each of the at least one window of events comprising one or multiple events in the stream of events. In some embodiments, the windows of events may overlap (e.g., meaning that the same event may be associated with two or more windows). In other embodiments the windows may not overlap, as aspects of the technology described herein are not limited in this respect. Thus, events in the stream of events may be organized into one window or multiple windows, which may be overlapping or not overlapping. As described below, each of the windows may be assigned a numerical representation which may be used to search against historical data of event streams that have been windowed using an analogous windowing with the resulting windows also assigned a numerical representation using an analogous numerical representation assignment method.

Any suitable windowing technique may be used to organize the events in the stream of events into at least one window of events. In some embodiments, one or more windowing parameters such as, time, number of events, or number or sequence of actions may be used to split the stream of events into smaller subsets or windows of events. For example, each set of events in the stream that is associated with a number of consecutive user actions (e.g., 2, 3, 4, 5, or other suitable number of consecutive actions) performed by the user may be organized into a window. As another example, each set of events in the stream that is associated with a particular timeframe (e.g., 10 seconds, 20 seconds, 30 seconds, 40 seconds, 50 seconds, 1 minute, 2 minutes, 5 minutes, 30 minutes, or other suitable timeframe) may be organized into a window. As yet another example, each set number of events (e.g., 5, 10, 15, 20, 25, 30, or any other suitable number) in the stream may be organized into a window.

In some embodiments, a time-based windowing technique may be used to group events that occur within a fixed time interval (e.g., every 10 seconds, 20 seconds, 30 seconds, 40 seconds, 50 seconds, 1 minute, 2 minutes, 5 minutes, 30 minutes, or other suitable interval). This approach captures user activity within consistent time slices, which is useful for continuous monitoring and workload analysis. However, it may fragment longer tasks that span multiple intervals or combine unrelated actions if the user is multitasking within the same period.

In some embodiments, an inactivity-based windowing technique may be used in which a new window starts whenever a user resumes activity after a defined idle period (for example, 2 minutes of inactivity). This approach is effective for modeling user sessions or task bursts and tends to capture natural boundaries in work behavior. It adapts better to variable task durations and avoids splitting meaningful sequences across arbitrary time limits.

In some embodiments, an event trigger-based windowing technique may be used where event-triggered windows are formed based on contextual transitions rather than fixed time or idle thresholds. These transitions can include changes in the active application, shifts between business contexts, or the duration of focus within a specific application where the user may need assistance. For example, a window can represent the continuous period a user spends working within a customer relationship management (CRM) system or enterprise resource planning (ERP) system. This approach is useful when assistance or retrieval is application-specific, ensuring that the captured context reflects the precise environment of the user's task.

In some embodiments, a sliding-based windowing technique may be used. Sliding windows advance by a fixed step (for example, a 5-minute slide on a 15-minute window) to ensure that transitional or overlapping activities between windows are captured. This method provides a continuous view of user activity and can help maintain context across shifting tasks, though it may introduce some redundancy if overlap is large.

Next, a numeric representation for each window of events may be generated. As described herein, numeric representations of windows of events may be then used to identify similar processes in historical digital interaction data. Generating a numeric representation for a window of events may be done hierarchically, whereby numeric representations of events in a window are determined first and subsequently are combined to provide a numeric representation for the window itself. Numeric representations of events may be generated using a trained embedding ML model (e.g., a trained neural network having a transformer based architecture, such as a BERT or ROBERTa architecture).

Accordingly, in some embodiments, at least one numeric representation corresponding to the at least one window of events may be generated using at least one trained embedding ML model. In some embodiments, metadata associated with the at least one window of events may be processed using the at least one trained embedding ML model to generate the at least one numeric representation corresponding to the at least one window of events. In some embodiments, the at least one trained embedding ML learning model includes a first trained embedding ML model. In some embodiments, each window of events of the at least one window of events may include a plurality of events and a numeric representation of the window may be generated by processing at least some of the metadata associated with events in the plurality of events using the first trained embedding ML model.

In some embodiments, generating a numeric representation of a window of events may include generating a numeric representation of each event of the plurality of events in the window using the first trained ML model to obtain a plurality of numeric representations corresponding to the plurality of events. In some embodiments, generating the numeric representation for each event comprises generating the numeric representation of the event by processing its associated metadata with the first trained ML model.

In some embodiments, generating the numeric representation of the event by processing its associated metadata with the first trained ML model comprises generating a textual event representation of the event using attribute-value pairs in the metadata associated with the event, tokenizing the textual event representation to obtain a tokenized event representation, determining an initial numeric encoding of the tokenized event representation, and processing the initial numeric encoding with the first trained ML model to obtain the numeric representation of the event. Examples of attribute-value pairs are provided in the table above.

An example of metadata associated with an event (e.g., interaction with an Order field in an SAP application screen) is shown below, where the metadata comprises attributes and values of the attributes.

| | Attributes | | | |
|---|---|---|---|---|
| | | Screen | Element | Element |
| | Application | Title | Type | Name |
| Values | Sap | SAP Easy Access | Guictextfield | Order |

A textual representation of the event generated using the values of these attributes may be sap_->_SAP_Easy_Access->_Guictextfield->Order. In some embodiments, the textual representation may be generated by following the steps below, although other textual representation formats may be used:
Within an event, all the different attributes are concatenated with the token ‘->’
Within an attribute, all spaces are replaced with ‘_’
Events are separated by spaces
Independent user days of events are separated by new line characters

In some embodiments, the special characters are different kinds of delimiters which are uniquely defined as special tokens in a tokenizer.

A tokenized event representation generated by tokenizing the textual representation above may be [‘s’, ‘ap’, ‘_’, ‘->’, ‘_’, ‘S’, ‘AP’, ‘_’, ‘Easy’, ‘_’, ‘Access’, ‘_’, ‘->’, ‘_’, ‘Gu’, ‘ic’, ‘text’, ‘field’, ‘_’, ‘->’, ‘_’, ‘Order’]. Any suitable tokenizing algorithm may be used to generate the tokenized event representation.

In some embodiments, an initial numeric encoding of the tokenized event representation above may be determined. The initial numeric encoding may be [0, 29, 1115, 1215, 46613, 1215, 104, 591, 1215, 43361, 1215, 35505, 1215, 46613, 1215, 14484, 636, 29015, 1399, 1215, 46613, 1215, 45613, 2]. In some embodiments, determining the initial numeric encoding may include determining a byte pair encoding (BPE) of the tokenized event representation. Each token may have a corresponding ID that is determined via byte pair encoding (BPE). BPE is typically used by tokenizers of BERT based models. For example, a ROBERTa tokenizer may be used to tokenize the textual representation and generate the initial numeric encoding.

In some embodiments, the numeric representation of the event may be obtained by processing the initial numeric encoding above with the first trained ML model. In some embodiments, the BPE may be converted to a numeric representation using an embedding layer of the BERT based model.

In some embodiments, the first trained ML model may include an encoder including a trained neural network having a transformer-based architecture, such as, a BERT model architecture described in Devlin et. al., “BERT: Pre-training of Deep Bidirectional Transformers for Language Understanding,” Computation and Language, arXiv: 1810.04805, May 2019 or a ROBERTa model architecture described in Liu et al., “A Robustly Optimized BERT Pretraining Approach,” Computation and Language, arXiv: 1907.11692, July 2019, both of which are incorporated by reference herein in their entirety). In some embodiments, a trained ML model that is a variation of the BERT and/or ROBERTa models may be used, as aspects of the technology described herein are not limited in this respect.

In some embodiments, ROBERTa may use the same transformer-based architecture as BERT, which comprises several layers of multi-headed attention and feed-forward neural networks. However, ROBERTa may implement some optimizations to improve pretraining such as dynamic masking, omitting the next sentence prediction task and increasing the batch size. This modification may allow ROBERTa to capitalize on larger training datasets and longer training durations, enhancing its ability to learn the underlying structure in the data, capturing complex linguistic patterns and nuances.

In some embodiments, ROBERTa may operate by first tokenizing input text into sub-word or word tokens, each mapped to a high-dimensional embedding vector. These embeddings may then be fed into transformer blocks, where multi-head self-attention mechanisms and position-wise feed-forward networks refine the contextualized representations of tokens. By iteratively encoding the input sequence through multiple transformer blocks, ROBERTa may capture semantic and structural intricacies in the data. A pooling strategy may be employed to aggregate contextualized token embeddings into a fixed-size vector representation for the entire input sequence. This final representation may serve as input for downstream applications.

In some embodiments, the first trained ML model is configured to process the first portion of the metadata that includes attribute values that do not include natural language text and/or complex values such as textual phrases, sentences, paragraphs, etc. Whereas a second trained ML model may be configured to process a portion of the metadata that includes attribute values taking on natural language text values. In some such embodiments, multiple different trained ML models may be used to generate numeric representations.

In some embodiments, the at least one trained machine learning model includes a second trained ML model different from the first trained ML model. In some embodiments, each window of events may include a plurality of events and a numeric representation of the window may be generated by processing at least some of the metadata associated with events in the plurality of events using the first trained ML model and at least some other of the metadata associated with events in the plurality of events using the second trained ML model.

In some embodiments, generating a numeric representation (which can equivalently be termed a numeric embedding) of each event of the plurality of events in the window may include generating a first numeric representation of the event by processing a first portion of the metadata associated with the event with the first trained ML model and generating a second numeric representation of the event by processing a second portion of the metadata associated with the event with the second trained ML model.

In some embodiments, the second trained ML model is configured to process the second portion of the metadata that includes attribute values that include natural language text and/or complex values such as textual phrases, sentences, paragraphs, etc.

In some embodiments, the second trained ML model may include an encoder having a trained neural network having a Sentence-BERT architecture described in Reimers et. al., “Sentence-BERT: Sentence Embeddings using Siamese BERT-Networks,” Computation and Language, arXiv: 1908.10084, August 2019, which is incorporated by reference herein in its entirety. Sentence-BERT is a modification of the pretrained BERT network that use siamese and triplet network structures to derive semantically meaningful sentence embeddings that can be compared using cosine-similarity. Sentence-BERT is pretrained on natural language data.

In some embodiments, the first numeric representation output from the first trained ML model may be a first multi-dimensional embedding (e.g., an embedding having 768 dimensions) and the second numeric representation output from the second trained ML model may be a second multi-dimensional embedding (e.g., an embedding having 384 dimensions). In some embodiments, the first and second numeric representation may be concatenated to generate the numeric representation of the event. For example, the numeric representation of the event may be a multi-dimensional embedding obtained by concatenating the first and second multi-dimensional embeddings (e.g., 768+384=1152-dimensional embedding). This numeric representation or embedding contains data about different attributes associated with the event including some attributes that are associated with natural language text and others that are not.

For example, metadata associated with an event corresponding to an interaction with an email application (e.g., clicking the send button to send an email message) may specify values for the following attributes: application, element name, element type, and text. The value of the application attribute may be “Outlook”, the value of the element name attribute may be “Send”, the value of the element type attribute may be “Button”, and the value of the text attribute may be “Email body” which includes natural language text. For this example, a first portion of the metadata (e.g., values of the first three attributes-application, element name, and element type) associated with the event may be processed with the first trained ML model to generate a first numeric embedding of the event and a second portion of the metadata (e.g., value of the fourth attribute—text) associated with the event may be processed with the second trained ML model to generating a second numeric embedding of the event. These first and second numeric embeddings may be concatenated to generate a numeric embedding for the event. In some embodiments, the attribute values (e.g., email bodies, paragraphs in a document) associated with the second portion of the metadata may be pre-processed prior to generating the numeric embedding of the event. The inventors have recognized that some events may be associated with metadata including similar values for certain attributes (e.g., the “text” attribute including natural language text) and it may be beneficial to preprocess these events by applying clustering techniques. For example, when interacting with an email application to send or reply to a message, the body of the email during both these events may be similar. In some embodiments, the attribute values (e.g., email bodies) associated with both these events may be processed using the Sentence-BERT model to generate corresponding embeddings. Based on these embeddings, clustering may be performed to merge together attribute values that are similar. The attribute values for each event may then be mapped to the attribute value of the corresponding cluster medoids before forming the textual event representation. For example, considering two email events with representations “outlook_->Email_Body_One_->Button->_Send” and “outlook_->Email_Body_Two_->_Button_->Reply”. If these events are preprocessed by applying clustering to the email bodies, and assuming that both email bodies are clustered into one group and its medoid is “Email Body One”, then the textual event representations for these events would be modified to “outlook_->Email_Body_One_->Button_->Send” and “outlook_->Email_Body_One_->_Button_->_Reply”.

Given numeric representations or embeddings of each of multiple events in a window, those representations may be combined to obtain the numeric representation of the window of events. In some embodiments, combining the plurality of numeric representations (of events) may include averaging the plurality of numeric embeddings to obtain the numeric representation of the window of events. In other embodiments, combining the plurality of numeric representations (of events) may include determining a weighted average of the plurality of numeric representations to obtain the numeric representation of the window of events. Determining the weighted average may include weighting the plurality of numeric representations based on durations and/or recency of the plurality of events from which the plurality of numeric representations were derived.

Accordingly, in some embodiments, the at least one window of events includes a first window comprising a first plurality of events. In some embodiments, generating the at least one numeric representation corresponding to the at least one window of events includes generating a first numeric representation of the first window, wherein generating the first numeric representation of the first window comprises: for each particular event in the first plurality events, processing event data for the particular event using the trained embedding ML model to obtain a numeric representation for the particular event, thereby generating numeric representations of events in the first plurality of events; and combining the numeric representations of the events in the first plurality of events to obtain the first numeric representation of the first window.

In some embodiments, combining the numeric representations of the events in the first plurality of events to obtain the first numeric representation of the first window includes normalizing each of the numeric representations to obtain normalized numeric representations; and generating the first numeric representation of the first window as a weighted average of the normalized numeric representations. In some embodiments, generating the first numeric representation of the first window as a weighted average, optionally, comprises weighting the normalized numeric representations based on durations and/or recency of events from which the normalized numeric representations were derived.

In some embodiments, each window of events includes information as shown in the table below.

| Column | Description |
|---|---|
| Window UUID | Unique identifier for the |
| | window session (primary key) |
| Machine Name | Name of user's machine |
| Date | Date of captured session |
| Start Time | Start timestamp of the session |
| End Time | End timestamp of the session |
| Event Count | Total number of events in the window |
| Window vector | Numerical representation of the window |
| Window frequency | How often is this window seen in the data |

The information in the table above may be used to lookup the numerical representation of the window for purposes of identifying instances of the process in a stream of events. In some embodiments, the numerical representation of the window may be created by using a series of operations on all the numerical representations of the events in the window. An example implementation of this is mean pooling with normalization, optionally weighted by each event's importance or time.

In some embodiments, the numerical representation of a window may be obtained as follows:
1. L2-normalize each event vector eᵢ.
2. Choose a weight wᵢ for each event (for example, dwell time, recency decay, or 1 if unweighted).
3. Compute the weighted mean:

$$v = \frac{{\sum }_{i} {w}_{i} {e}_{i}}{{\sum }_{i} {w}_{i}} .$$

4. L2-normalize v to get the final numerical representation of the window.

In some embodiments, weighting may be performed using techniques like term frequency-inverse document frequency (TF-IDF) of events that have been seen in the data to determine uniqueness of the information.

In some embodiments, the numerical representation of a window comprises a representation of the digital interactions that were performed in that window of time. Window frequency can then be used to not only find semantically similar series of digital interactions, but ones that are commonly performed by users of a team. This can be useful in generating a ranking of steps when deciding what series of steps of a process are to be suggested to the user.

In some embodiments, a plurality of measures of similarity may be obtained by determining a measure of similarity between the numerical representation of the window and each of multiple stored and previously-determined numeric representations of respective windows of events in the multiple streams of event data in the historical digital interaction data. In some embodiments, determining the measure of similarity may include determining a cosine similarity between the numeric representation of the window and each of multiple stored and previously-determined numeric representations of respective windows of events. In some embodiments, a similarity score may be obtained by computing the cosine similarity between the numeric representation of the window and each of multiple stored and previously-determined numeric representations of respective windows of events. The similarity score may be a value between 0-1, a higher score indicating a better match than a lower score.

In some embodiments, a numeric representation of the window is compared with each of multiple stored and previously-determined numeric representations of respective windows of events. As part of this comparison, the ith dimension of the numeric representation may be compared to the ith dimension of the stored numeric representation. In other words, the dimensions that embed the first portion of the metadata are compared to one other and the dimensions that embed the second portion of the metadata are compared to one another. This comparison makes process discovery extendable and capable of using data from multiple domains.

In some embodiments, the determined plurality of measures of similarity may be used to identify the instances of the process in the stream of events as comprising events in those windows whose determined measure of similarity to the numeric representation of the window was greater than a first threshold (e.g., 0.7 or 70%). Any suitable first threshold may be used.

Aspects of techniques for generating numerical representations of windows and identifying instances of the process using determined measures of similarity can be found in PCT Application No. WO2024/214113, titled “Machine learning systems and methods for automated process discovery,” published Oct. 17, 2024, which is incorporated by reference herein in its entirety.

In some embodiments, an example series of steps performed to identify instances of a process for purposes of guiding users is described below:
1. Normalize the numeric representation of the window q with L2 normalization.
2. Index all stored and previously-determined numeric representations of respective windows vⱼ in a vector store. Normalize them once at ingest.
3. Similarity metric: use cosine similarity. With normalized numerical representations, cosine similarity is the same as the dot product.
4. Search: retrieve top-k nearest neighbors of q.
5. Filter: apply metadata filters if needed, for example machine name, date range, or application.
6. Score and threshold: keep results with similarity >a chosen cutoff to avoid weak matches.
7. Rank and Judge: Using the Window Frequency information and language models, optionally judge the quality of the results.
8. Return: the matching windows, their similarity scores, and any metadata needed to display examples.

There are many different ways to store, index, and search these numerical representations as described above. One such example, used in some embodiments, is using pgvector with Postgres, which provides several indexing methods and top-k nearest neighbor implementations. By default, that would be a Euclidean (L2) distance for top-k and an index type of Inverted Flat File index (ivfflat).

A top-k search may be performed, for example with a default of top 5, to find similar windows of digital interactions that match the one the user is currently experiencing.

With the top-k results some ranking steps may be performed. Since the top-k results will be based on semantics and not necessarily frequency, Window Frequency may be used to perform ranking (e.g., which may indicate popularity of the sequence of steps). In this way, the search may find semantically similar sequences, which can then be re-ranked by Window Frequency. The idea here is that a high Window Frequency may indicate that multiple users/teams perform such steps, increasing their value to guiding other users.

In some embodiments, classification labels may assist in helping identify processes. For example, if the process a user is performing during a captured window can be associated with a classification label, that information can be stored alongside the numerical representation of the window as structured metadata (in the interaction database 240, for example). The process label may represent the task or workflow context, such as updating a record, submitting a claim, or reviewing an application. By associating this classification with the numerical representation, each window becomes semantically richer and more interpretable, allowing downstream systems to reason about both the vectorized behavioral pattern and its categorical intent. This turns the numeric representation of the window into a multimodal artifact that blends numeric embeddings with symbolic context.

In some embodiments, when performing the similarity search, such process classifications may be used to refine retrieval results. For example, before the similarity search, the process type can act as a filter, returning only windows that match the same process category as the query. Alternatively, after retrieving the top-k results by semantic similarity, the process classification label can influence the ranking, giving higher priority to windows associated with the same or closely related process types. This combined approach improves both precision and relevance by ensuring that the returned examples are not only similar in user behavior and screen context but also aligned with the user's current task or intent.

Referring back to FIG. 4, the method proceeds to act 430, where the query and the generated context (local and/or organizational context) may be processed by a language model 230 to obtain a response to the query. In some embodiments, a prompt for the language model may be generated using the query and the context, and the language model may be prompted with the prompt to obtain output including guidance for the first user performing the process. In some embodiments, the guidance may indicate one or more suggested acts for first user to perform in furtherance of performing the process.

The method proceeds to act 440 where the response may be output. In some embodiments, outputting the response includes presenting the first user with the one or more suggested acts that the first user could perform in furtherance of performing the process.

It will be appreciated that the techniques described herein may incorporate additional forms of context to be used by the language model, in addition to the local and/or organizational context, without departing from the scope of this disclosure. As an example, information regarding what process the user is or was performing can be provided as context to the language model, for example the context may include a sentence regarding the process, such as “The user is or was performing a process of creating Sales Invoices”. As another example, context about multiple users or the team in the organization may be provided to the language model including information regarding the processes that the users in the team perform, for example, the context may include a sentence, such as “As additional context, the team performs any of the following processes: Invoice Creation, Invoice Cancellation, Purchase Order Creation, etc.”

It will be further appreciated that the techniques described herein may be used for improving responses of language models in various ways without departing from the scope of this disclosure.
The techniques described herein may be used to generate more accurate and informative responses by prompting language models to answer questions, summarize text or extract relevant information from a text or document in view of the local and/or organizational context.
The techniques described herein may be used with image generation models which are commonly used by organizations, e.g., to generate logos, marketing material, product images, etc. The input to these models is often text to describe what type of image is needed. These image generation models can be provided with local and/or organizational context to produce more accurate and contextualized images. The local and/or organizational context may be provided to video generation models as well for generating more accurate and relevant videos (series of images).
When generating synthetic data using generative models local and/or organizational context may be provided to generate better synthetic data. That data could be for generating information such as synthetic digital interaction data and synthetic process workflows as an example.

### Other Implementation Details

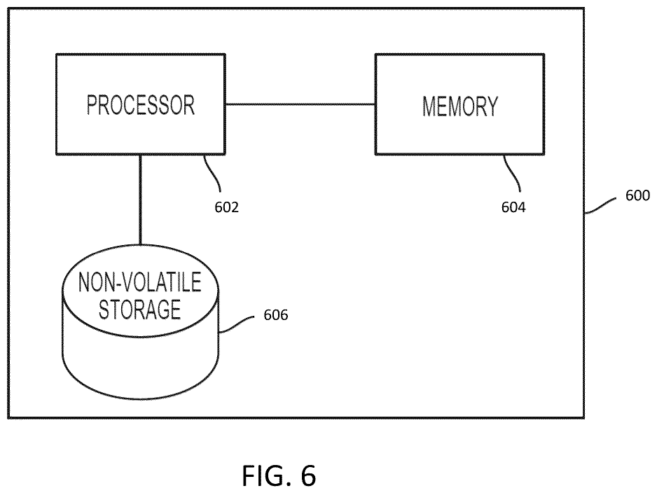

An illustrative implementation of a computer system 600 that may be used in connection with any of the embodiments of the disclosure provided herein is shown in FIG. 6. For example, any of the computing devices described above may be implemented as computing system 600. The computer system 600 may include one or more computer hardware processors 602 and one or more articles of manufacture that comprise non-transitory computer-readable storage media (e.g., memory 604 and one or more non-volatile storage devices 606). The processor 602(s) may control writing data to and reading data from the memory 604 and the non-volatile storage device(s) 606 in any suitable manner. To perform any of the functionality described herein, the processor(s) 602 may execute one or more processor-executable instructions stored in one or more non-transitory computer-readable storage media (e.g., the memory 604), which may serve as non-transitory computer-readable storage media storing processor-executable instructions for execution by the processor(s) 602.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

There is a number of documents incorporated by reference herein. However, to the extent that any aspect of a document incorporated by reference conflicts with the present disclosure, the present disclosure controls.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of using language models to respond to queries about a process performed by multiple users in an organization, the method comprising:
using at least one computer hardware processor to perform:
receiving a query about the process performed by multiple users in the organization;
generating context to be used by a language model in responding to the query, the generating comprising:
obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and
including the obtained historical digital interaction data as part of the context;
processing the query and the generated context by using the language model to obtain a response to the query; and
outputting the response.

2. The method of claim 1,
wherein the multiple users include a first user who performed, is performing, or will be performing the process;
wherein receiving the query comprises receiving the query from the first user; and
wherein outputting the response comprises outputting the response to the first user.

3. The method of claim 2, further comprising:
identifying, within the historical digital interaction data, at least one instance of the process previously performed by at least one user; and
including, as part of the context, at least a portion of the historical digital interaction data corresponding to event data associated with the at least one instance of the process previously performed by the at least one user.

4. The method of claim 3, wherein identifying the at least one instance of the process comprises:
identifying, using instance identifiers associated with previously-determined numeric representations of multiple instances of the process stored in a database, the at least one instance of the process previously performed by the at least one user.

5. The method of claim 3, wherein:
the first user is performing the process using at least one application program executing on a first computing device;
the identifying the at least one instance of the process comprises:
obtaining a first stream of event data corresponding to a series of interactions between the first user and the at least one application program;
identifying, within the historical digital interaction data and using the first stream of event data, the at least one instance of the process previously performed by at least one user; and
the method further comprises:
including, as part of the context, the first stream of event data and the at least a portion of the historical digital interaction data corresponding to the event data associated with the at least one instance of the process previously performed by the at least one user.

6. The method of claim 5, wherein the first stream of event data contains event data for each event in a stream of events, and wherein identifying the at least one instance of the process comprises:
organizing events in the stream of events into at least one window of events, each of the at least one window of events comprising one or multiple events in the stream of events;
generating, using at least one trained embedding machine learning (ML) model, at least one numeric representation corresponding to the at least one window of events;
determining a measure of similarity between the at least one numeric representation and each of multiple stored and previously-determined numeric representations of respective window of events in the multiple streams of event data in the historical digital interaction data to obtain a plurality of measures of similarity; and
identifying, using the determined plurality of measures of similarity, the at least one instance of the process in the stream of events.

7. The method of claim 6,
wherein the at least one window of events comprises a first window comprising a first plurality of events,
wherein generating the at least one numeric representation corresponding to the at least one window of events comprises generating a first numeric representation of the first window,
wherein generating the first numeric representation of the first window comprises:
for each particular event in the first plurality of events, processing event data for the particular event using the at least one trained embedding ML model to obtain a numeric representation for the particular event, thereby generating numeric representations of events in the first plurality of events; and
combining the numeric representations of the events in the first plurality of events to obtain the first numeric representation of the first window.

8. The method of claim 5, further comprising:
generating a prompt using the query and the context; and
prompting the language model with the prompt to obtain output including guidance for the first user performing the process.

9. The method of claim 8, wherein:
the guidance indicates one or more suggested acts for first user to perform in furtherance of performing the process, and
outputting the response comprises presenting the first user with the one or more suggested acts that the first user could perform in furtherance of performing the process.

10. The method of claim 5, further comprising:
identifying at least a portion of the first stream of event data to be provided as context to the language model.

11. The method of claim 10, wherein identifying the at least a portion of the first stream of event data to be provided as context to the language model comprises:
receiving, via a graphical user interface, user input indicating one or more parameters to refine the first stream of event data; and
refining the first stream of event data based on the user input to obtain the at least a portion of the first stream of event data to be provided as context to the language model.

12. The method of claim 1, wherein:
receiving the query comprises receiving a request to generate an audit trail for the process; and
the processing comprises processing the request and the generated context by using the language model to obtain a response to the request including the audit trail for the process.

13. A system comprising:
at least one computer hardware processor; and
at least one non-transitory computer-readable storage medium storing instructions that, when executed by the at least one computer hardware processor cause the at least one computer hardware processor to perform a method of using language models to respond to queries about a process performed by multiple users in an organization, the method comprising:
receiving a query about the process performed by multiple users in the organization;
generating context to be used by a language model in responding to the query, the generating comprising:
obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and
including the obtained historical digital interaction data as part of the context;
processing the query and the generated context by using the language model to obtain a response to the query; and
outputting the response.

14. The system of claim 13,
wherein the multiple users include a first user who performed, is performing, or will be performing the process;
wherein receiving the query comprises receiving the query from the first user; and
wherein outputting the response comprises outputting the response to the first user.

15. The system of claim 14, wherein the method further comprises:
identifying, within the historical digital interaction data, at least one instance of the process previously performed by at least one user; and
including, as part of the context, at least a portion of the historical digital interaction data corresponding to event data associated with the at least one instance of the process previously performed by the at least one user.

16. The system of claim 15, wherein identifying the at least one instance of the process comprises:
identifying, using instance identifiers associated with previously-determined numeric representations of multiple instances of the process stored in a database, the at least one instance of the process previously performed by the at least one user.

17. The system of claim 15, wherein:
the first user is performing the process using at least one application program executing on a first computing device;
the identifying the at least one instance of the process comprises:
obtaining a first stream of event data corresponding to a series of interactions between the first user and the at least one application program;
identifying, within the historical digital interaction data and using the first stream of event data, the at least one instance of the process previously performed by at least one user; and
the method further comprises:
including, as part of the context, the first stream of event data and the at least a portion of the historical digital interaction data corresponding to the event data associated with the at least one instance of the process previously performed by the at least one user.

18. The system of claim 17, wherein the method further comprises:
generating a prompt using the query and the context; and
prompting the language model with the prompt to obtain output including guidance for the first user performing the process.

19. The system of claim 18, wherein:
the guidance indicates one or more suggested acts for first user to perform in furtherance of performing the process, and
outputting the response comprises presenting the first user with the one or more suggested acts that the first user could perform in furtherance of performing the process.

20. At least one non-transitory computer-readable storage medium storing processor executable instructions that, when executed by at least one computer hardware processor, cause the at least one computer hardware processor to perform a method comprising:
receiving a query about a process performed by multiple users in an organization;
generating context to be used by a language model in responding to the query, the generating comprising:
obtaining historical digital interaction data associated with the process, the historical digital interaction data comprising multiple streams of event data generated through multiple users performing the process, each of the multiple streams of event data corresponding to interactions between a particular user performing the process and one or more application programs executing on a particular computing device associated with the particular user; and
including the obtained historical digital interaction data as part of the context;
processing the query and the generated context by using the language model to obtain a response to the query; and
outputting the response.
